(19) United States
(12) Patent Application Publication
(10) Pub. No.: US 2013/0158678 A1
(43) Pub. Date: Jun. 20, 2013

(54) METHOD OF CONTROL OF TECHNICAL EQUIPMENT

(71) Applicant: ABB TECHNOLOGY AG, Zurich (CH)

(72) Inventors: Nicolaie L. FANTANA, Heidelberg (DE); Christopher GANZ, Zurich (CH)

(73) Assignee: ABB TECHNOLOGY AG, Zurich (CH)

(21) Appl. No.: 13/768,796

(22) Filed: Feb. 15, 2013

Related U.S. Application Data
(63) Continuation of application No. PCT/EP2010/005048, filed on Aug. 17, 2010.

(51) Int. Cl. G05B 15/02

(52) U.S. Cl. CPC G05B 15/02
USPC 700/9

(57) ABSTRACT

The disclosure relates to a method and system for control and remote monitoring the condition of a technical equipment or plant provided with tags or labels as an electronic identifier where a user identifies the apparatus/machine, while on-site, a unique ID, stored data on the tag and sensor data are read, a mobile device application sends a control request from the identified apparatus to a central automation system for approval. The request and data can be analyzed by the central automation system to determine: is control request allowed/authorized so that no misoperation is possible; and which functionality is allowed via mobile device. If control is allowed, then the commands, related to configuration, action, and the like, requested are sent to the central automation/control system for controlling/passing the commands, and executing command for the technical equipment.

### RELATED APPLICATION(S)

This application claims priority as a continuation application under 35 U.S.C. §120 to PCT/EP2010/005048 filed as an International Application on Aug. 17, 2010 designating the U.S., the entire content of which is hereby incorporated by reference in its entirety

### FIELD

The disclosure relates to a method and system for at least one of control and monitoring a condition of a technical equipment or plant for a person on-site. The equipment is provided with tags or labels as electronic or visual identifiers and data transmission is provided by electronic communication.

### BACKGROUND INFORMATION

In modern industry facilities, for example, plants or complex equipment, the use of semi-automated or automated production is common. Often a central operation station is provided as well as on site control panels.

Control of an individual apparatus, machine or equipment can be possible from the central operating station using, for example, faceplates, command interfaces or built-in panels on the equipment. Not all equipment can be controlled using local control panels and may need central intervention.

Therefore, the control of the apparatus, machine or equipment while on site may not be possible with the same functionality and detailed information as that can be provided in the central station by, for example, faceplates for command and visualization, configuration, historical information on process values, service history, and the like.

Not all safety preconditions may be known on-site when in front of the equipment to control it properly. The connection to the control station or control station operator, as well as the coordination with the person on site for safe operation, can be complex and misunderstanding and misoperations can occur.

According to modern contractual customs, the maintenance and the service of the respective facility can be observed by its manufacturer who may not be located at the same location as the facility to be controlled and/or monitored but remote from there. Also, an outside-company charged with such work will want the information about the respective equipment.

### SUMMARY

A method is disclosed for control and remote monitoring of a condition of technical equipment, provided with tags as an electronic identifier, by a processor coupled to a non-transitory memory, the method comprising: identifying technical equipment on-site by a unique ID, and stored data on the tag, and reading sensor data from the equipment; sending a control request for the identified technical equipment from on-site, by a mobile device using a mobile device application, to a central automation system for approval; analyzing the request and data by the central automation system for determining: whether the control request is allowed/authorized; which functionality is allowed via the mobile device; and sending allowed commands to the central automation system for executing commands for the technical equipment.

A system is disclosed for control and remote monitoring of a condition of technical equipment comprising: tags as electronic identifiers provided for the technical equipment, wherein the tags contain sufficient relevant data about a location, a usage rate, a load and load cycles of a respective object; and a communication device for transmission of the data to be sent to a processor arranged as a central automation system via the communication device, the data being sufficient for a central automation system to process the received data for generating appropriate commands for receipt by the electronic identifiers via the communication device.

### BRIEF DESCRIPTION OF THE DRAWINGS

Exemplary embodiments of the disclosure are explained in more detail below on the basis of the accompanying drawing, in which:

FIG. 1 is a schematic of a plant area according to an exemplary embodiment of the disclosure with equipment to be controlled and/or monitored.

### DETAILED DESCRIPTION

An exemplary embodiment of the disclosure provides a method of allowing a de-centralized but safe and co-coordinated control of a technical equipment while the person to handle these tasks is on site, being approved by the central control station or system and furnished with substantial and sufficient monitoring power and competence for the equipment operation available at the remote plant location.

Exemplary embodiments of the disclosure include appropriate devices for identification, for example, electronically and/or visually, of the respective equipment to be maintained, serviced, and/or monitored as well as for identification of the respective person who is charged with such work.

Consequently, each respective object is being identified by an electronic device (e.g., a processor) reading its specific tag or label including all (e.g., sufficient data) relevant data (e.g., in a memory) about its location, its usage rate, its load and/or load cycles. The respective response can be sent to the central control station or to a central automation system (e.g., a processor) via electronic communication, whereas the received response including the respective data can be processed in the automation system, and the automation system can generate appropriate commands which are received by the respective electronic identifiers (arranged as e.g., a processor) via the electronic communication and executed.

In an exemplary embodiment of the method according to the disclosure:

Step 1: The user identifies the apparatus/machine, while on-site. A unique ID, stored data on the tag and possibly also sensor data are read;

Step 2: A mobile device application sends a control request including the data for identification of the apparatus on site and optionally other data of the identified apparatus to the automation system for approval as well as with regard to the person who is charged to execute these actions.

Data for identification of the person wearing the mobile device and works on site can be sent, too.

Step 3: The request and data are analysed by the central automation system for the following criteria;
is control request allowed/authorized such that no misoperation is possible;
which functionality is allowed via mobile device, for example, only view of configuration, values from process, graphs/curves over time, service actions or also control actions.

Step 4: If control is allowed then the commands, related to configuration, action, and the like, requested are sent to the central automation/control system which is controlling/passing the commands, executing commands for the apparatus/machine.

The steps above in short are:
request for operation or monitoring;
check by central system;
confirmation;
allow control from site, build on mobile device faceplate of device;
user commands;
view/monitor and sent commands to central station to be executed for on-site equipment.

The short version as shown above can be important when using an operational faceplate which is created on the mobile device thus corresponding approvals are given to operate from this faceplate.

The tags or labels for identification purposes being mentioned before and being fixed to the respective equipment or to the respective person can, for example, be passive RFID (radio-frequency identification) tags or labels as common and barcodes (1D, 2D) as well as NFC-(near field communication) tags, active RFID-tags, wireless sensor node or hybrid tags or labels which can include electronically stored data and information as visually displayable information.

According to an exemplary embodiment of the disclosure, the data to be read from the respective identifier can be transmitted via cable communication, which can be a local area network, a wide area network or a telephone communication line.

In an exemplary embodiment of the disclosure, the data to be read from the respective identifier can be being transmitted by wireless communication interface whereas the wireless communication interface for transmission of data read from the respective identifier can be, for example, WLAN or Bluetooth.

For example, the wireless communication interface can be provided with access points as well as with repeaters to cover the area of the plant.

Exemplary embodiments of the disclosure are directed to a system that can operate according to the methods of exemplary embodiment of the disclosure.

Accordingly such system for control and remote monitoring of the condition of a technical equipment or plant can be provided with tags or labels as electronic identifiers using electronic communication and:
the respective object is provided with specific tags or labels for identification which include all relevant data about the location, the usage rate, the load and load cycles of the respective object;
electronic communication can be provided for transmission of the specific data to be sent to a central automation system via electronic communication;
the automation system is processing the received response including the respective data; and
the automation system is generating appropriate commands which are being received by the respective electronic identifiers via the electronic communication and executed.

According to an exemplary embodiment of the disclosure, the specific tags or labels for identification can be provided with printed information to be read electronically, for example, barcodes.

An exemplary embodiment of this system according to the disclosure includes the specific tags or labels for identification which are provided with electronic identifiers, for example, active or passive RFID whereas instead of a passive or active RFID the electronic identifier can be, for example, a barcode, or a NCF-tag, or a wireless sensor node. Furthermore hybrid tags can be used as electronic identifier which provides as well visual information by a barcode as an RFID within one tag or label.

An advantage of visual identification is based on the fact that known smartphones equipped with a built-in camera can be used and an RFID reader may not be necessary.

In an exemplary embodiment of this system according to the disclosure, cables can be used for the transmission of the information included in the specific tags or labels from the monitored and/or controlled area to the automation system. Examples can include wide area network (WAN) or a telephone communication line.

In an exemplary embodiment of the system according to the disclosure, the wireless communication can be provided for the transmission of the information included in the specific tags or labels from the monitored and/or controlled area to the automation system.

The wireless communication can be, for example, a wireless local area network (WLAN) or Bluetooth, or mobile telephone communication.

By the enclosed drawing, advantageous designs and modifications of the disclosure, as well as improvements and specific advantages of the disclosure shall be illustrated and described in more detail.

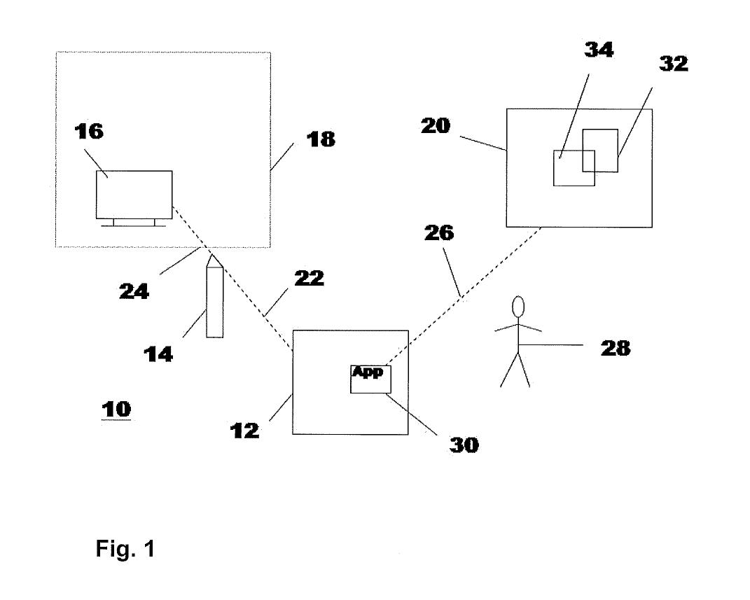

In FIG. 1, a schematic of a plant area 10 is depicted being provided with equipment 18 to be controlled and/or monitored by respective devices, for example, a mobile device 12 for transmission, electronic reader/writer 14 for evaluation of the respective electronic tag 16 which is fastened to the respective plant component 18.

The mobile device 12 can be a mobile personal computer, for example, a netbook or a laptop, a personal digital assistant, or a smartphone which are equipped for interconnection to a central automation system 20 which is provided for evaluation and determination of corrections and/or desired measures.

The data being stored in the respective electronic tag which is communicating with a plurality of sensors and receiving data about the condition of the respective part of the machine are taken by the electronic reader via communication line 24 and forwarded to the mobile device 12 via communication line 22.

The mobile device 12 transmits the data received from the electronic reader via communication line 26 to the central automation system 20. According to an exemplary embodiment of the disclosure, the communication line 26 can be a cable, for example, of a local area network or of a wide area network or a telephone line whereas the mobile device 12 is operated by a person 28.

The communication line 26 can also be a wireless connection, for example, a Bluetooth connection or a wireless local area network respectively via radio frequency transmission.

Additionally the following aspects can lead to better features and functionality.

The request containing the apparatus/machine's identifier, sensor data, data stored in the apparatus/machine is passed to a Control Request module 32, which can be a software system with own intelligence such as a rule based expert-system or a case-based system or any other. The module 32 is using input data from the request and all available data in the system 20 and—if desired—data taken from the service system, from other enterprise systems for the installed base, observing as well safety rules as constraints.

The allowed functionality derived from the evaluation of the data is passed to a module 34 which generates a functional and layout description of the user interface to be later shown on the mobile device with controls and visualization functions allowed on the mobile device 12 and for the user 28. This information is sent back to the mobile device 12, for example a proprietary description file, for example, an xml file.

On the mobile device the functional and layout description is passed to an interface generator engine which produces the interface with all functionality and displays it to the user 28.

Elements which could be available to the user are, for example:
the equipment control panel on mobile device (faceplate, control plate,) with process data and sensor data, for example, from the apparatus 18, too, and from other sources in the close-up range of the apparatus 18;
the configuration Interface for setting parameters;
the command interface, for example, on/off, faster/slower, up/down, dry/wet;
the operational parameter history, for example, from an OPC UA server OPC is the acronym of OLE for Process Control (OPC), which stands for Object Linking and Embedding (OLE) for Process Control. OPC UA is the acronym of OPC Unified Architecture and is the most recent OPC specification.

OPC is a technology (system and protocol) that allows embedding and/or linking to documents and other objects and thus provides communication between different applications and creation of heterogenous compound documents.

For example, the desired OPC-UA details, for example, server, object, node, are stored in an RFID tag and after reading the data is taken and presented on a mobile device. All functionality such as history, alarms etc. accordingly is available.
Service history, for example, from a service system;
Installed base details on, for example, equipment close to the identified apparatus.

Exemplary embodiments of the present disclosure have been described with respect to the operative features the structural components perform. The exemplary embodiments of the present disclosure can also be implemented by at least one processor (e.g., general purpose or application specific) of a computer processing device (including hardware, software or a combination of both) which is configured to execute a computer program tangibly recorded on a non-transitory computer-readable recording medium, such as a hard disk drive, flash memory, optical memory or any other type of non-volatile memory. Upon executing the program, the at least one processor is configured to perform the operative functions of the above-described exemplary embodiments.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE LIST

10 plant area
12 mobile device
14 reader/writer
16 electronic tag or electronic label
18 plant or complex equipment
20 automation system
22 communication from reader to mobile device, for example, wireless via Bluetooth or WLAN or via cable (USB)
24 communication from reader to electronic tag
26 communication from mobile device to automation system
28 person handling the mobile device
30 mobile device application
32 input control request module
34 evaluation and display module

What is claimed is:

1. A method for control and remote monitoring of a condition of technical equipment, provided with tags as an electronic identifier, by a processor coupled to a non-transitory memory, the method comprising:
identifying technical equipment on-site by a unique ID, and stored data on the tag, and reading sensor data from the equipment;
sending a control request for the identified technical equipment from on-site, by a mobile device using a mobile device application, to a central automation system for approval;
analyzing the request and data by the central automation system for determining:
whether the control request is allowed/authorized;
which functionality is allowed via the mobile device; and
sending allowed commands to the central automation system for executing commands for the technical equipment.

2. The method according to claim 1, comprising:
transmitting at least one of the stored date and the sensor data to be read via cable communication.

3. The method according to claim 1, comprising:
transmitting at least one of the stored data and the sensor date the data to be read by wireless communication.

4. The method according to claim 3, comprising:
transmitting the wireless communication by WLAN.

5. The method according to claim 3, comprising:
transmitting the wireless communication by Bluetooth.

6. The method according to claim 1, wherein the wireless communication is provided with access points as well as with repeaters to cover an area of a plant containing the technical equipment.

7. A system for control and remote monitoring of a condition of technical equipment comprising:
tags as electronic identifiers provided for the technical equipment, wherein the tags contain sufficient relevant data about a location, a usage rate, a load and load cycles of a respective object; and
a communication device for transmission of the data to be sent to a processor arranged as a central automation system via the communication device, the data being sufficient for a central automation system to process the received data for generating appropriate commands for receipt by the electronic identifiers via the communication device.

8. The system according to claim 7, wherein the tags are provided with printed information to be read electronically.

9. The system according to claim 7, wherein the tags are provided with electronic identifiers.

10. The system according to claim 7, comprising:
a cable provided for transmission of information included in specific tags or labels from a monitored and/or controlled area to the central automation system via LAN or telephone communication.

11. The system according to claim 10, wherein the cable is for LAN or telephone communication.

12. The system according to claim 7, comprising:
a wireless communication interface for transmission of the information included in the tags from a monitored and/or controlled area to the central automation system.

13. The system according to claim 12, whereas the wireless communication is for a WLAN.

14. The system according to claim 12, whereas the wireless communication is Bluetooth.

15. The system according to claim 12, whereas the wireless communication is a mobile telephone communication.

16. The system according to claim 8, wherein the tags are barcodes.

17. The system according to claim 9, wherein the electronic identifiers are active or passive RFID.
